(19) United States
(12) Patent Application Publication
(10) Pub. No.: US 2018/0297826 A1
(43) Pub. Date: Oct. 18, 2018

(54) PORTABLE HOIST ASSEMBLY SYSTEM

(71) Applicant: Donald E. HADDIX, II, Scottsdale, AZ (US)

(72) Inventor: Donald E. HADDIX, II, Scottsdale, AZ (US)

(73) Assignee: HOIST ALL, INC., San Diego, CA (US)

(21) Appl. No.: 16/011,469

(22) Filed: Jun. 18, 2018

Related U.S. Application Data
(63) Continuation-in-part of application No. 14/120,722, filed on Jun. 20, 2014, now Pat. No. 10,000,368.
Application No. 14/120,722 is a continuation-in-part of application No. PCT/US2017/014171, filed on Jan. 19, 2017.

(51) Int. Cl. B66D 3/20; B66D 3/04

(52) U.S. Cl. CPC B66D 3/20; B66F 7/065; B66D 3/04

(57) ABSTRACT

A portable hoist assembly that includes a base structure with fastening means that can be engaged and disengaged to secure the hoist assembly on various anchoring structures. The portable hoist assembly can be control using a control unit that can also monitor the operation of the hoist assembly and thus ensuring safe operation.

This application is a Continuation-in-Part Application of prior application Ser. No. 14/120,722, filed on Jun. 20, 2014, this Application is also a Continuation-in-Part of prior International Application No. PCT/US2017/014171, filed Jan. 19, 2017, both of which are fully incorporated herein by reference.

### BACKGROUND OF THE INVENTION

### Field of the Invention

The present invention relates to a method and apparatus for lifting construction or other materials.

### Discussion of the Related Art

A Those of skill in the art have, for many years, endeavored to provide improved apparatus and methodology to safely lift and maneuver construction materials.

Although hoisting loads is a ubiquitous practice, there is no equipment available for personal use that can be easily installed and operated. Most hoist systems available instead are either fixed in position and often permanently integrated with a given structure or construction vehicle. This makes their accessibility very limited for personal use and also requires large costs for installation.

Therefore, it would be highly desirable to provide an improved apparatus and method in this respect.

Therefore, it is a principal object of the instant invention to provide an improved apparatus and method to lift and position a load using a portable device that can be easily relocated as necessary.

### SUMMARY OF THE INVENTION

Accordingly, the present invention is directed to a portable hoist assembly that substantially obviates one or more of the problems due to limitations and disadvantages of the related art.

An advantage of the present invention is to provide a portable hoist assembly system that can easily be used in various environments without necessitating a bulky crane or like equipment.

Another advantage of the present invention is to provide a hoist assembly system that can also be safely used.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a portable hoist assembly system having a portable hoist assembly and a portable pulley assembly. The portable hoist assembly having a hoist including a cable and a motor, and a support base including a plate, wherein the plate is attached to the hoist. At least one fastener is located on the support base for removably securing the portable hoist assembly to a first anchoring structure. The portable pulley assembly includes a pulley and one or more fasteners for removably secure the pulley assembly to a second anchoring structure.

A portable hoist assembly including a hoist with a cable and a motor. The hoist assembly also having a pulley assembly including a pulley. A support base including a plate is attached to the hoist. The support base having at least one fastener to securing the portable hoist assembly.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a front view illustrating a portable hoist used to retrofit a scissor lift in accordance with the principles of the invention;

FIG. 2 is a side view illustrating the portable hoist of FIG. 1 mounted on a scissor lift in accordance with the invention;

FIG. 3 is a top view illustrating a bridle utilized in one embodiment of the invention;

FIG. 4 is a slide elevation view of the bridle of FIG. 3 illustrating the mode of operation thereof.

FIGS. 5A-5D illustrate exemplary designs of back support plate 12, including exemplary surface features of back side of back support plate 12.

### DETAILED DESCRIPTION OF THE ILLUSTRATED EMBODIMENTS

Reference will now be made in detail to an embodiment of the present invention, example of which is illustrated in the accompanying drawings.

Provided is an improved portable hoist assembly system. The hoist assembly system can include a portable hoist assembly and a portable pulley system. The portable hoist assembly can be used independently or to retrofit an anchoring structure such as vehicle or fixed structure where the hoist system is to be employed.

Any fixed structure that is resilient enough for the load to be lifted can be used as an anchoring structure to which the hoist assembly described herein can be attached. In preferred embodiments, the anchoring structure is heavier than the load to be lifted. Non-limiting, exemplary fixed structures may include posts, poles, walls, trees, boulders, man-made structures such as scaffoldings, machines, tanks, crates, and other objects that are sufficiently heavy or can be sufficiently weighted down or anchored to support the load of the lift.

In exemplary embodiments, the hoist assembly can be used to retrofit a vehicle. The type of vehicle is not limited. In preferred embodiments, the vehicle used as the anchoring structure is heavier than the load to be lifted. Non limiting examples of vehicles that may be retrofitted with the hoist assembly described herein include automobiles, vans, sports utility vehicles, trucks, recreational vehicles such as all-terrain vehicles (ATVs), motorcycles, aircrafts, water crafts, semi, trailer trucks, moving trucks, wagons, tractors, and construction vehicles such as cranes, dump trucks, backhoes, bulldozers, air lifts, boom lifts, and forklifts.

The portable hoist assembly can include a hoist mounted on a plate or back support structure or both. The hoist can include a rotatable shaft, and an elongate cable wound on the shaft. The cable has a proximate end mounted on the shaft and a deployable distal end. The cable can also include a structure on the distal end to engage at least one item to be lifted by the hoist. The hoist can also include a motor connected to the shaft to rotate the shaft in at least two directions, a first forward direction to deploy the cable, and a second reverse direction to retract the cable. The hoist can also include an electrical cable having a proximate end connected to the motor and a distal end shaped and dimensioned to connect to a battery or external power supply 70 to provide power needed to operate the motor. The hoist can also include a manually operated control unit connected to the motor to operate the hoist to deploy and retract the cable. The portable hoist assembly can also include at least one pulley mounted on the cable intermediate the proximate and distal ends of the cable, an apparatus to secure the pulley to an overhead structure in a building, and, apparatus to detachably securely mount the support structure on the scissors lift.

Turning now to the drawings, which depict a non-limiting, illustrative exemplary embodiment of the invention, in which like reference characters refer to corresponding elements throughout the several views.

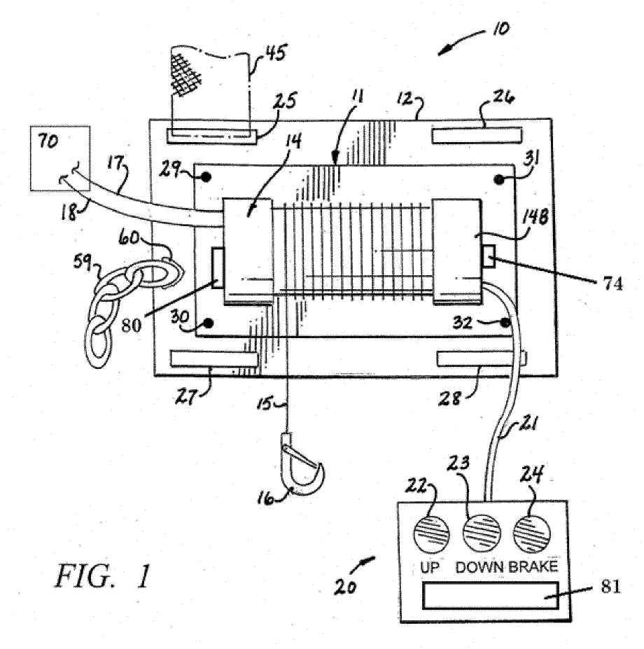

FIG. 1 illustrates an exemplary embodiment of the portable hoist assembly main body 10. In the illustrative embodiment, the hoist assembly can includes a hoist 14, equipped with a cable 15, the hoist 14 being mounted on a plate 11 and optionally to an additional back support 12. The hoist assembly can also include a control unit 20, a motor 14B, and one or more electrical leads 17 and 18.

In order to maintain portability of the hoist assembly, in exemplary embodiments, the total weight of the hoist assembly will be no more than 100 lb. In exemplary embodiments, the hoist assembly as described herein will weight from 60 to 90 lb. In alternative embodiments, the hoist assembly described herein will weight from 70 to 80 lb.

Hoist 14 can includes a cylindrical shaft around which a cable 15 can be wound. The size and weight of the hoist 14 is not limited and can be modified according to the expected use of the hoist assembly. In exemplary embodiments, the hoist assembly is employed to lift heavy structures and thus may be designed to be more sturdy and heavier to better manage the load. In alternative embodiments, where the hoist assembly is used for smaller loads, the hoist assembly can be made of lighter material.

In exemplary embodiments, the hoist 14 includes a steel shaft 14A around which cable 15 is wound. In alternative embodiments, the shaft of hoist 14 can be any metal or other material that can sustain the strain imposed by the load to be lifted. Additional exemplary materials may be aluminum, wood, plastic, iron, titanium, and tungsten. Also, alloys and mixture of two or more of the above or other metals may be used. For example, the shaft 14A can be made of a steel/aluminum alloy.

Cable 15 is also preferably designed to be sufficiently strong for the intended load to be lifted. In exemplary embodiments, cable 15 is made of steel. Other materials may also be used. For example, metal alloys such as steel/aluminum alloy may be used for cable 15. The diameter of cable 15 is also not limited. In exemplary embodiments the cross section of cable 15 is rounded with a diameter ranging from 1/16 of an inch to ¼ of an inch. It should be noted that cable 15 should not be excessively thick as that would add unnecessary weight to the hoist assembly making it more difficult to carry and install.

Cable 15 can be wound around shaft 14A and deployed and retracted using motor 14B as described below. A proximal end of cable 15 can be secured to shaft 14A. The cable 15 may be secure by tying it around shaft 14A. Alternatively cable 15 may be secured to shaft 14A by a mechanical means, such as a bolt, clamp, or other securing device. At the other end of cable 15, the distal end, cable 15 can be connected to an engaging mechanism 16. The engaging mechanism can aid in securing a load to cable 15. The engaging mechanism 16 is optional. Engaging mechanism 16 is not limited to any particular structure. For example, engaging mechanism 16 can be a hook. Alternatively, engaging mechanism 16 can be a clamp. Alternatively, engaging mechanism can be a magnet that can be powered either remotely or by adapting cable 15 to also safely carry a current to engaging mechanism 16. The current applied to engaging mechanism 16 can be controlled by a control unit 20. In exemplary embodiments, engaging mechanism 16 may be an interchangeable mechanism that can be modified depending on the load to be lifted. Any combination of the above described mechanisms can be employed and interchanged. The interchangeable parts can be secured using bolts, clamps, screws, fittings and other like devices.

Hoist 14 can also include a motor 14B. Like the shaft 14A and cable 15, motor 14B can be tailored to the intended loads to be lifted. Motor 14B can be a DC powered motor. Alternatively, motor 14B can be an AC powered motor. Motor 14B can be used to rotate shaft 14A. Motor 14B can be operated in multiple modes. For example, motor 14B can have a forward mode used to rotate shaft 14A in a first direction that allows cable 15 to be unwound. Motor 14B can also have a second or backward mode to rotate shaft 14A in a second direction that retracts deployed cable 15 by winding it back around shaft 14A. In non-limiting exemplary embodiments, the motor 14B can be powered by anywhere from 12 volt to 48 volt power source. For example the power source can be 12 volt, 24 volt or 48 volt power source. While the size of hoist motor 14B utilized can vary as desired, in exemplary embodiments where batteries are used, the motor 14B can be powered by four 12 volt or four 24 volt batteries wired in series. Each such battery may produce from thirty-six to forty-eight amps of current. Non limiting exemplary hoist motors that can be employed include a 12 volt, Model DC2000 (MF) sold by Warn Industries, Inc. Other hoist motors may also be used. In exemplary embodiments, the motor will be capable of lifting a load that is heavier than the intended use for the hoist assembly to improve safety. For example, in embodiments where the hoist assembly is designed to be used for 2000 lb loads, the motor employed can be one capable of lifting a load of 3000 lb.

In exemplary embodiments, hoist 14 can also include a brake. The brake can be a magnetic brake 80 that can clamp to and prevent rotation of shaft 14A. In embodiments, the brake can be a load holding brake that can prevent release of the load when the motor is stopped. The brake may also be designed to hold a load that is higher than the load intended for the overall hoist assembly so as to promote safety. In exemplary embodiments, where for example the hoist assembly is designed for 2,000 lb load, the brake can internally lock the motor and hold a load of 3500 lb to 4000 lb. Having a brake can be an important feature because it prevents the load being lifted by the hoist assembly from moving a short distance (i.e., from “drifting”) after motor 14A has been stopped. When motor 14A is stopped, it is preferred that the rotation of shaft 14A stop substantially immediately and completely. In exemplary embodiments, the brake is located inside motor 14B. The brake can be configured to allow a user to jog and stop the hoist within ⅛ of an inch. More or less sensitive brake systems can also be employed depending on the intended use of the hoist assembly.

Control unit 20 can be used to operate motor 14B. Control unit 20 can also be used to control the brake. Control unit 20 can be a controller equipped with one or more switches. Control unit 20 can be connected to motor 14B, the brake and any other controllable components of the hoist assembly, for example, by one or more electrical leads or cables 21. Cable 21 can be coiled (in the same manner that the cable leading from a telephone set to the telephone receiver is coiled) to reduce their length when not in use and to reduce the likelihood they will be run over or stepped on. Alternatively, cable 21 can be provided on a reel mechanism as described for example for electrical leads 17 and 18. In yet an alternative embodiment control unit 20 can communicate wirelessly via radio frequency, Bluetooth™ technology, or other wireless means. Control unit 20 is preferably manually held and operated to rotate shaft 14A to deploy cable 15, to rotate shaft 14A to retract cable 15, or to stop rotation of shaft 14A. In alternative embodiments, control unit 20 can be fixed onto plate 11 or back support structure 12. Control unit 20 can also be detachably connected to plate 11 or back support structure 12 so that it can be used either as a handheld control or as a panel control. Control unit 20 can be connected to plate 11 or back support structure 12 by any appropriate fastening means. For example, the fastening means can include a hook, a fitting, a clamp, one or more straps, Velcro™, a magnet or any combination thereof. Being able to attach control unit 20 to plate 11 or back support structure 12 can aid the transport of the hoist assembly.

Control unit 20 can include a simple control. For example, control unit 20 can include one or more buttons or switches to send command signals to motor 14B and the brake. In the illustrated embodiment, control unit 20 can include buttons 22, 23 and 24. Each button can have its own independent function. For example, button 22 can signal motor 14B to activate a mode that retracts cable 15 and thus lift any object that may be connected at the distal end of cable 15. Also, button 23 can signal the motor to activate a mode that releases cable 15, thus extending or lowering the distal end of cable 15 and any load that may be attached thereto. Button 24 can be used to activate a break as described above. Alternative embodiments may include fewer or more control buttons or switches. For example, the control unit 20 may include a single switch, like a dial or similar device that can be set to send various signals similar to the three buttons set up but by simply rotating the dial to different settings. Control unit 20 can also be connected to one or more sensors 74 installed on the hoist assembly 10. For example, the sensors can monitor one or more of the weight of the load, operating conditions of the motor 14B, conditions of the shaft 14A, conditions of the plate 11, conditions of the back support structure 12 if present, conditions of securing means 45 or 59 or both, conditions of the cable 15 or any combination thereof.

Control unit 20 may also include a display monitor 81 that can communicate the sensed conditions to the user. In exemplary embodiments, control unit 20 can also be equipped with a safety alarm to communicate to the user whether the hoist assembly is not safely installed or if the load exceeds the capabilities of the hoist assembly. The alarm can be visual, auditory, haptic or any combination thereof.

In exemplary embodiments, control unit 20, motor 14B, the brake or other components or any combination thereof in the hoist assembly can include one or more sensors that can signal unsafe operation of the hoist assembly and optionally prevent operation of motor 14B or of another portion of the system from operating if the weight being lifted exceeds a selected value or if the hoist assembly is not properly secured. The sensors can send a signal to control unit 20 and in response control unit 20 can send a signal to stop or prevent start of the motor 14B or to engage the brake or both. The selected maximum load value can vary. In exemplary embodiments the selected value is maximum of 2000 pounds. Other limits can also be set. For example the limit can be 2200 pounds; 2500 pounds, 3000 pounds, 3500 pounds, 5000 pounds. The limit can also be lowered such as 500 pounds, 750 pounds, 1000 pounds, 1500 pounds. In order to promote safety, in exemplary embodiments, the hoist assembly, including cable, shaft, motor, brake, plate, and other structure, will be designed to support a load that is at least 25% to 50% heavier than the load for the hoist assembly's actual intended use.

In an exemplary embodiment, shaft 14A can be operated by a manual crank. In an embodiment, the manual crank can be used in conjunction or as a backup to motor 14B. The crank can include a fixed handle on the side of hoist 14. The crank alternatively can include a handle that can be removably engaged with the gears that rotate shaft 14A. The crank handle can be fixed or engaged either on the same side as motor 14B. Alternatively, crank handle can be operated at the opposite of hoist 14 from motor 14B.

The portable hoist assembly 10, including motor 14B, brake, and control unit 20 can be powered via one or more electrical leads 17 and 18. The number of electrical leads is not limited and can be a single lead, two leads, three leads or more. The one or more electrical leads can be adapted to be attached to a portable power source such as one or more batteries or one or more battery packs 70. The one or more batteries 70 can be fixed to the portable hoist assembly 10 and thus portable along with hoist assembly 10. Alternatively, the one or more batteries 70 can be carried separately and connected when needed. In yet alternative embodiments, batteries 71 may be used to power the hoist assembly that also power a vehicle or structure to which the hoist assembly is attached. In exemplary embodiments, the power source, whether it be batteries or separate power source, can vary from 12 volt to 48 volt.

Electrical leads 17 and 18 can be adapted to be attached to an external electrical system. Any AC or DC external power 70 may be employed. In exemplary embodiments the power source can be from 12 volt to 48 volt. In exemplary embodiments it can be a 12 volt, 24 volt, or a 48 volt power source. The external power supply can be from a building, vehicle or other structure that is equipped with a power source. Electrical leads 17 and 18 can include an adaptor (not shown) to allow for connecting to various power sources. The adaptor is not limited and can include any known electrical adaptor. In exemplary embodiments, the adaptor can be an electrical plug, a USB connector, a car plug, alligator clamps for a battery such as for a car battery, a car lighter plug, and the like. It should be noted that the plug should be able to safely conduct the sufficient amount of power to operate the hoist assembly. In an exemplary embodiment, the one or more electrical leads 17 and 18 may have exchangeable adapters so that various sources of power can be connected and thus provide more flexibility on where to use the hoist assembly.

Electrical leads 17 and 18 can also be extendable to better reach an external power source. In exemplary embodiments, the hoist assembly may include a spring loaded reel (not shown) with optional lock and release means for one or more electrical leads. Thus, when necessary the one or more leads 17 and 18 can be manually unreeled and optionally locked in place. An exemplary reeling system is described in U.S. Pat. No. 3,705,962, which is incorporated herein by reference. When the use of the hoist assembly is complete, the one or more electrical leads 17 and 18 can be reeled back. This can improve the convenience of the portability of the hoist assembly 10. In exemplary embodiments, electrical leads 17 and 18 can be coiled (in the same manner that the cable leading from a telephone set to the telephone receiver is coiled) to reduce their length when not in use and to reduce the likelihood they will be run over or stepped on.

Portable hoist assembly 10 also includes a supporting base. The supporting base can include a plate 11. Optionally, the supporting base can also include a back support structure 12. Hoist 14 can be fixed to plate 11 by any secured means. In exemplary embodiments, hoist 14 is fixed to plate 11 using one or more fasteners 29, 30, 31, 32. Exemplary fasteners can be bolts. In alternative embodiments, hoist 14 can be fixed to plate 11 by welding. Other means may also be used, such as adhesive, screws, clamps, and the like. The same or additional fasteners can be used to also connect back support structure 12. In exemplary embodiments hoist 14, plate 11 and back support structure 12 are held together by common fasteners. In alternative embodiments, plate 11 and back support structure 12 are connected with a first set of fasteners and hoist 14 and plate 11 are connected via a second set of fasteners.

Plate 11 and back support structure 12 can be made of any suitable material that can provide sufficient strength to the assembly for the intended load. In exemplary embodiments, plate 11 and back support structure 12 can be made of steel. In alternative embodiments, plate 11 and back support structure 12 can be made of wood, plastic, or a metal such as tungsten, iron, titanium, aluminum or any mixtures or alloys thereof. In exemplary embodiments, the plate 11 and back support structure 12 can be made of an aluminum/steel alloy. Plate 11 and back support structure 12 can be made of the same material. Alternatively, plate 11 and back support structure 12 can be made of different materials.

In the illustrated embodiment plate 11 and back support structure 12 are shown as rectangular. However, plate 11 and back support structure 12 can be of any desired shape that can accommodate hoist 14. Plate 11 can have the same shape or different shape as back support structure 12. Plate 11, however, is generally smaller in size than back support structure 12, so that plate 11 can fit over back support structure 12. Plate 11 can generally have a rigid structure at least over the area underlying hoist 14. In exemplary embodiments, hoist assembly 10 does not include a back support structure 12. Back support structure 12 can provide more structural stability to the hoist assembly 10.

Aside for the rigid portion underlying hoist 14, plate 11 and back support structure 12 can have similar designs. For ease of reference, the below features to fix hoist assembly 10 to an anchoring structure are described with respect to back support structure 12, however, it should be understood that the same features can be applied to plate 11, especially in embodiments where back support structure 12 is not used. Also, in exemplary embodiments, the back side of plate 11, where it is joined to back support structure 12, can be configured to contour the adjoining surface of back support structure 12 so as to achieve full contact between plate 11 and back support structure 12. In exemplary embodiments, a rubber material or a heat sink material 73 may also be fitted between plate 11 and back support structure 12 to better insulate hoist 14 from any heat transfer with the anchoring structure.

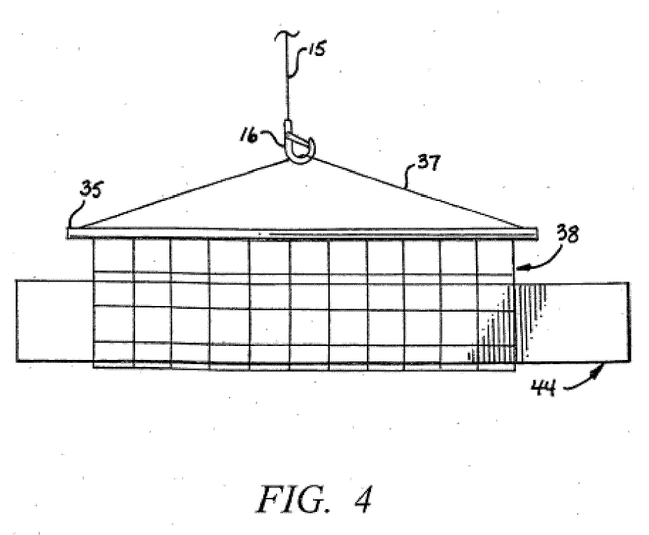

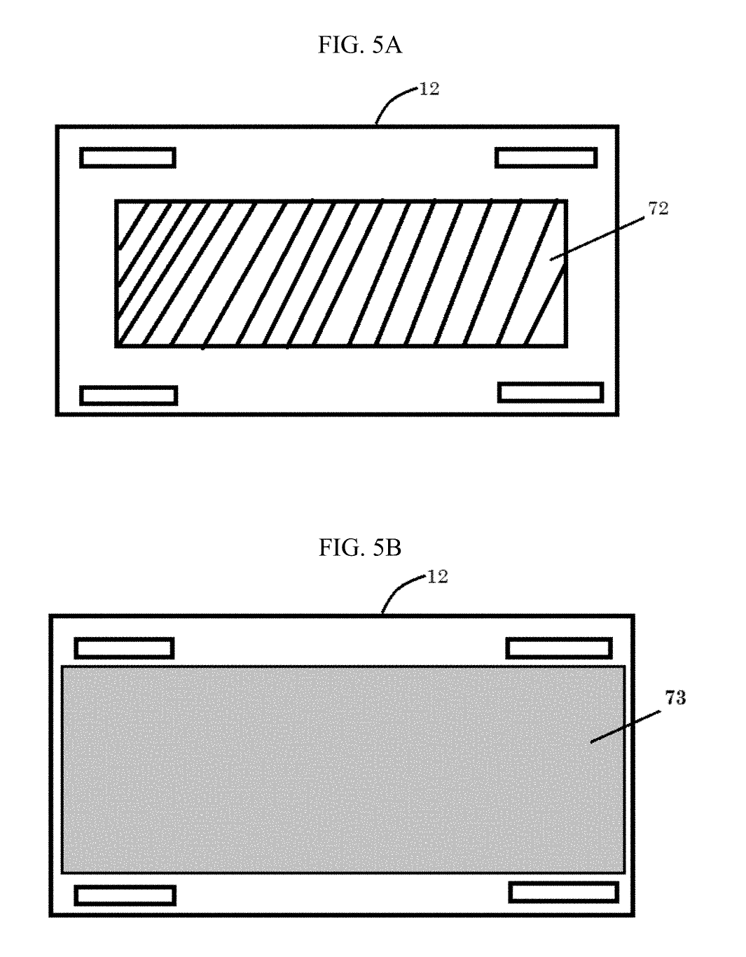

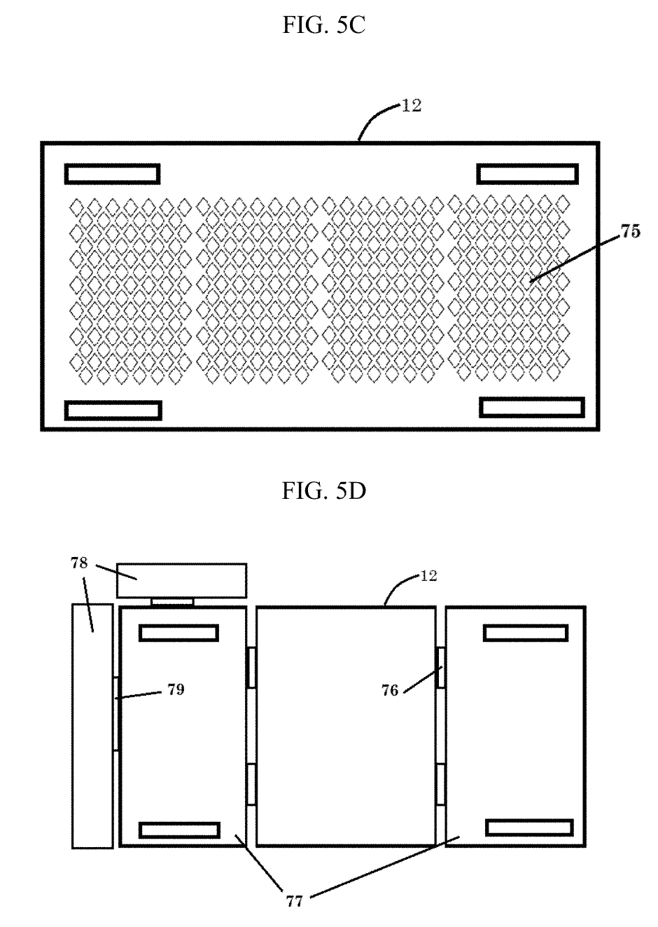

Back support structure 12, or plate 11 if back support structure 12 is not used, can also be designed to be removably mounted on an anchoring structure. For example, as illustrated in FIG. 1, back support structure 12, or plate 11 if back support structure 12 is not used, can include slots 25, 26, 27, 28 formed through the plate so that each one of four fasteners 45, such as attachment straps, can be threaded through a different one of slots 25 to 28 to engage a selected portion of an anchoring structure. The straps are not limited and can be made of fabric, metal, synthetic materials such as nylon, or any combination thereof. In exemplary embodiments, the straps can have a load limit of 5,000 to 15,000 lb. In an exemplary embodiment the straps have a load limit of 10,000 lb. In alternative embodiments, different fastening means can also be used in place of straps and slots. For examples, chains, bolts, nails or screws can be used in place of straps. Slots 25, 26, 27 and 28 can be designed in any shape to properly fit the fasteners. Slots 25, 26, 27, and 28 can be squared, round, rectangular, or any other suitable shape. In yet alternative embodiments, four clamps (not shown) can be placed at the location of slots 25, 26, 27, and 28. Alternatively, as illustrated in FIG. 5A, the back surface of back support structure 12, or plate 11 if back support structure 12 is not used, that faces the anchoring structure may be provided with a magnet 72. For example an electrically powered magnet. In such an embodiment, the power to the magnet can be supplied from the one or more leads 17 and 18, and the magnetic engagement and disengagement can be controlled using control unit 20. In exemplary embodiments, any combination of two or more of the above fasting means can be used in combination.

Also, as illustrated in FIG. 5B, in exemplary embodiments, to better improve contact between back support structure 12, or plate 11 if back support structure 12 is not used, and an anchoring structure, the surface of back support structure 12, or plate 11 if back support structure 12 is not used, can be roughened. Alternatively, a layer of compressive material 73, such as for example rubber, can be provided on the surface of back support structure 12, or plate 11 if back support structure 12 is not used, such that the compressive material is pressed against the anchoring structure. Such compressive material can provide better friction and thus improved stability of the hoist assembly once installed. The compressive material can also improve heat transfer between the hoist assembly and the anchoring structure. Other features to better connect the hoist assembly to the anchoring structure may also be implemented. For example hooks or spikes or similar structures may be provided that can insert into the anchoring structure when for example the anchoring structure is wood or other material that allows hooks or spikes to be inserted.

In exemplary embodiments, the hoist assembly can have sets of interchangeable plates 11, each plate 11 having different features or design or both. Likewise, each hoist assembly can also have a set of interchangeable back support structures 12, each with its own features or design or both. The back support structure 12 and plate 11 can also be independently selected. Different plate 11 designs, different back support structure 12 designs or both can be used to ease installation with various anchoring structures. In such a system, the plate 11 or back support structure 12 or both can be changed depending on the application. As illustrated as illustrated in FIGS. 5C and 5D with respect to back support structure 12, each plate 11 can be flat, curved, concave, convex, rounded, squared, rectangular, have a smooth surface, or a structured surface, a structured surface includes roughed surface, spiked surface, and a surface having hooks, as also shown for back support structure 12, each plate 11 can also include additional layers such as heat sinks, anti-slip layers or any combination of any two or more of these features. Plate 11 can also come in different sizes. Likewise, as illustrated in FIGS. 5C and 5D, back support structure 12 can independently be flat, curved, concave, convex, rounded, squared, rectangular, have a smooth surface, or a structured surface 75, a structured surface includes roughed surface, spiked surface, and a surface having hooks, back support structure 12 can also include additional layers 73 such as heat sinks, anti-slip layers or any combination of any two or more of these features. Back support structure 12 can also come in different sizes. A hoist assembly 10 can then be adjusted for a specific application by selecting the appropriate plate 11. Likewise, the appropriate back support structure 12 can independently be selected. Plate 11 and back support structure 12 can be the same or different designs and have the same or different components. In this manner, each of the plate 11 or the back support structure 12 or both can be selected and installed based on the specific application. Likewise, the interchangeability of plate 11 can increase its functionality when used without back support structure 12. Thus, allowing for increased flexibility in the adjustability and selection of the overall design of the supporting base.

In exemplary embodiments, additional attachments can be provided that can securely lock with back support structure 12 or plate 11 or both. Each attachment can be designed to have a specific contour, design and include specific materials so that it can be used for a particular application as similarly described above with respect to the various designs for back support structure 12 and plate 11. For example, attachments can include rounded surfaces to better engage rounded anchoring structures.

Moreover, as illustrated in FIG. 5D, back support structure 12 or plate 11 or both can be provided with adjustable portions 77 to better contour to the shape of the anchoring structure. Back support structure 12 or plate 11 or both can also be provided with hinged portions 78 at the perimeter that can be made to embrace an anchoring structure. For example, in embodiments where the anchoring structure is a pole, tree or vehicle bumper, hinged peripheral portions of back support structure 12, or of plate 11 if back support structure 12 is not used, can be bent so that back support structure 12 or plate 11 or both can better conform to the round or narrow shape of the pole, tree, or vehicle bumper thus allowing for a more secured attachment to the anchoring structure. The hinges design is not particularly limited and can be made of the same material used for the back support structure 12 or plate 11. The hinges 76 and 79 can also allow for the back support structure 12 or plate 11 or both to also lay flat when used against an anchoring structure having a flat surface that is larger than the surface of back support structure 12 or plate 11 or both.

Back support structure 12 or plate 11 or both can also be equipped with additional safety features 59 and 60. As illustrated in FIG. 1, the additional safety features include a chain 59 connected to back support structure 12 by way of welding 60 or otherwise attached to the back support structure 12 or plate 11. The chain 59 can, for example, have a load limit of 10,000 to 15,000 lb. In exemplary embodiments, instead of chains, these safety features can include straps, cable, clamps, bolts, nails or the like. Welding 60 can be replaced by an opening of appropriate shape in the case bolts, or nails are used. The additional safety features can be designed to be able to attach to the anchoring structure by any known means such as hooks, locks, clamps, by tying around the anchoring structure, or any other available means.

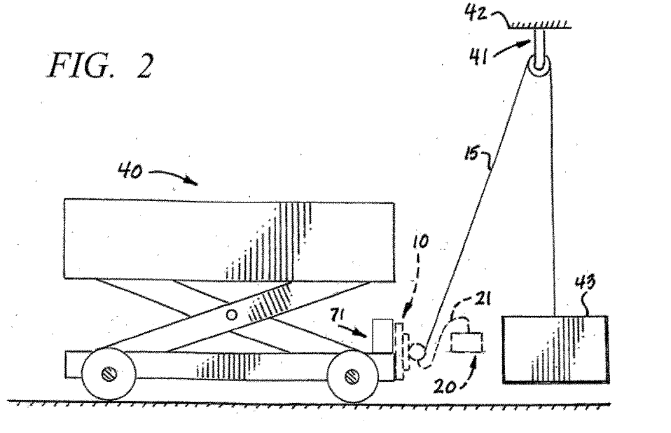

As illustrated in FIG. 2 in conjunction with an exemplary embodiment employed with a scissor lift, the portable hoist assembly system can also include a remote and also portable pulley assembly that includes a pulley 41 that can be removably secured to a secondary anchoring structure to allow for lift of a load. The secondary anchoring structure can be a joist 42. However, other structures can be used depending on the environment in which hoist assembly is to be used. For example, pulley 41 can be installed on a tree branch, a pole, a building, a portion of a vehicle such as for example the roofing of a truck or trailer, or any like anchoring structure that can provide sufficient strength to support the load. In addition to pulley 41, the pulley assembly can also include one or more fasteners to secure the pulley assembly to the joist 42 or other secondary anchoring structure. Similar fastening means described above for the hoist assembly 10 can be used to secure the pulley assembly. Non limiting examples include straps, chains, bolts, nails, screws, clamps, magnets or any combination thereof as previously described. In an exemplary embodiment, the pulley assembly may include a sling that can wrap around a secondary anchoring structure such as a beam or branch. The sling can be engaged by a hook, ring, clamp or like device attached to pulley 41.

Pulley assembly can be made of any suitable material that can sustain the load to be lifted. In exemplary embodiments the pulley assembly can be made of steel. Other materials can also be used. Any of the materials used for the hoist assembly including for the hoist 14 can be used for the pulley assembly. For example, pulley assembly can be made of an aluminum/steel alloy.

Pulley assembly can also be equipped with sensors 74 that can monitor the load imposed on the pulley assembly and can communicate such information to control unit 20. Control unit 20 can then display such information to the user. The communication between pulley assembly, including the sensors 74, and control unit 20 can be conducted wirelessly. If wireless connection is engaged, in exemplary embodiments, it can be conducted via radio frequency, Bluetooth™ technology, or any other wireless technology. To power the wireless communication, pulley assembly may also be equipped with a compact battery pack (not shown) designed not to interfere with the operation of the pulley assembly.

The pulley assembly can be mounted to accommodate cable 15 such that the pulley 41 can move along cable 15 at locations intermediate the distal and proximate ends of cable 15. Consequently, when pulley 41 is removably connected to a secondary anchoring structure, such as joist 42, the wheel in pulley 41 can turn freely when cable 15 moves through pulley 41.

### Exemplary Applications

In the illustrated exemplary embodiment of FIGS. 2 to 4, the hoist assembly is shown in conjunction with a scissor lift along with a method for utilizing the system. The hoist assembly can be used to retrofit a scissor lift to elevate and position construction materials 43 and 44. The scissor lift can include at least one battery used in the operation of the scissor lift. As discussed earlier, the application to a scissor lift is only exemplary as the hoist assembly can be used with various vehicles as well as fixed structures. The utilization of the hoist assembly described and illustrated herein in conjunction with a scissor lift is only for ease of reference. Similar retrofitting are equally applicable to the other vehicles mentioned above and can also be employed for non-vehicular structures exemplified earlier.

When used in conjunction with a scissor lift, the hoist assembly can be especially suited to lifting transformers, ducting, etc. in confined spaces in a building. Currently, lifting such pieces of construction equipment 43 and 44 in confined spaces is labor intensive, and can be relatively dangerous. The apparatus and method of the invention are believed to greatly facilitate and simplify such operations. In exemplary embodiments using a scissor lift, the external electrical system of a scissors lift 40 (FIG. 2) can be used to connect to the one or more electrical leads 17 and 18 of the hoist assembly so that the batteries of the scissors lift can be utilized to power the motor 14B, control unit 20 and other electrical components of the hoist assembly 10.

Plate 11, or another back support structure 12 attached to plate 11 or hoist 14, is removably mounted on a scissors lift 40 (FIG. 2). For example, as previously shown in FIG. 1, back support structure 12 can have slots 25, 26, 27, 28 formed through the plate so that each one of four attachment straps 45 can be threaded through a different one of slots 25 to 28 to engage a selected portion of a scissors lift 40 and detachably secure back support structure 12 (and therefore the hoist assembly 10) to scissors lift 40. As described earlier, other methods can also be used to secure hoist assembly 10 to scissors lift 40. In addition to straps 45, one or more safety features are also engaged to connect hoist assembly 10 to scissors lift 40. For example, one or more chains 59 welded to back support structure 12 can be used to further secure the hoist assembly to scissors lift 40.

The hoist assembly may also be connected to the power source for scissors lift 40. The connection can be made, for example, using the one or more electrical leads 17 and 18. For example, the hoist assembly can be connected to a battery power that also powers the scissors lift. The hoist assembly can also include the control unit 20 to control the operation of the hoist motor 14B. In an exemplary embodiment, control unit 20 can be connected to the hoist assembly by a cable 21.

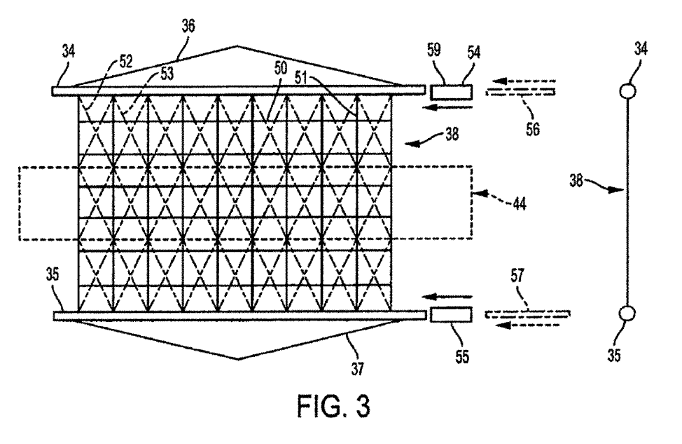

A bridle or net structure 38 can also be used in conjunction with the hoist assembly 10. As for example illustrated in FIGS. 3 and 4, a bridle or net structure 38 can include netting 38 attached to and spanning between a pair of elongate poles 34, and 35. The ends of a lift cable 36 and 37 can be attached to each pole 34, and 35 respectively. The netting can be sized to fit around a length of ducting 44 in the manner illustrated in FIG. 4. Netting 38 can include strands which are each perpendicular to or parallel to poles 34, and 35 in the manner epitomized by strands 50 and 51. Importantly, in exemplary embodiments, the strands of netting 38 be canted with respect to poles 34, and 35, as epitomized by the strands 52 and 53 drawn in dashed line form in FIG. 3. If desired, sleeves 54, and 55 can be provided and each removable fit or snap on an end of a pole 34 and 35 and also removably receive the end of an extension pole 56, and 57, respectively.

The hoist assembly and the bridle 38 can be packed together as a portable hoist kit for a scissors lift or other anchoring structure.

The portable hoist kit can be transported to a building structure in which air conditioning ducting or other construction equipment 44 is being suspended and installed. A scissors lift 40 can be provided at the building structure. Four mounting straps 45 can be used to removably attached back support structure 12—and therefore the hoist assembly—to the scissors lift 40 in the manner illustrated in FIG. 2.

The pulley assembly with pulley 41, can be already pre-installed on cable 15 so that cable 15 threads through pulley 41. The pulley assembly can be detachably secured to an overhead joist 42 of the building structure in the manner illustrated in FIG. 2.

Bridle 38 can be laid on the floor in the manner illustrated in FIG. 3. A length of ducting 44 can be placed on the bridle 38 such that the ends of the ducting extend beyond the netting in the manner illustrated in FIG. 3.

Lift cables 36, and 37 can then each be engaged with a hook 16 in the manner illustrated in FIG. 4. In so doing, poles 34 and 35 can then be lifted off the floor using the hoist to reel in cable 15. Control unit 20 can be used to operate the hoist assembly to lift the bridle and ducting 44 off the floor to a desired height above the floor. When button 22 of unit 20 (FIG. 1) is manually depressed, motor 14B rotates shaft 14A in a direction which winds or retracts cable 15 onto shaft 14A. When button 23 of unit 20 is manually depressed, motor 14B rotates shaft 14A in a direction which deploys cable 15 from shaft 14A. When button 24 of unit 20 is manually depressed, rotation of shaft 14A stops. Electrical wiring or leads 17 and 18 can be a fifty foot cable which at its distal ends (not shown) has alligator clips which can be attached to the posts of a battery.

A worker can enter the basket of the scissors lift, the scissors lift being operated to raise the basket so the worker can install the ducting 44. By operating control unit 20, the height of ducting 44 can be adjusted above the floor.

In an alternate embodiment of the invention, the hoist assembly is not mounted on a scissor lift but is mounted on another piece of equipment or is mounted on the wall or ceiling of a building structure, for example in the bay of an automobile repair facility. Pulley 41 would normally then be mounted at a desired location on the ceiling of the bay.

In an alternative exemplary embodiment the hoist assembly can be used in conjunction with a recreational activity. For example, the hoist assembly may be used in conjunction with hunting. In such a setting, the hoist assembly 10 can be detachably connected or secured to the trunk of a tree. The back surface of plate 11 or back support structure 12 if present, can optionally include a roughened surface or spiked back surface to more firmly engage with the tree. The back surface, i.e. the surface that contacts the tree trunk, can also be curved to better conform to the contours of the tree trunk. In exemplary embodiments, back support structure 12 can have hinged peripheral portions that can be bent to better embrace the tree trunk. Fastening means 45 such as straps and safety fasteners 59 such as chains can be wrapped around the tree trunk so as to firmly secure the hoist assembly to the tree trunk. The pulley assembly can be detachably installed on a branch of the tree. The pulley assembly can use a sling to wrap around the branch and a hook to engage the pulley 41 to the sling. The hoist assembly may be powered by a portable 12V battery pack. Alternatively, the hoist assembly can be powered by connecting electrical leads 17 and 18 to a vehicle such as an ATV, truck or tractor. A control unit 20 can be used to operate the hoist assembly to release and reel a cable 15 engaged by the pulley 41 of the pulley assembly. The distal end of the cable 15 can be provided with a hook 16 or other connecting means to attach to a load. The load can include a shelter. In alternative embodiments, the load can be the carcass of an animal.

In yet another exemplary embodiment, the portable hoist assembly can be used in conjunction with an overhead car lift. The type of overhead car lift is not limited. An exemplary overhead car lift is the two posts Atlas® PV-10P lift as for example sold by Greg Smith Equipment of Indianapolis, Ind. The hoist assembly can be secured to one of the two posts using any suitable means. For example, the hoist assembly can be detachably connected using fastening means 45 such as straps, and safety fasteners 59 such as a chain or additional straps. The back surface of plate 11 or back support structure 12 can be smooth to achieve full contact with the post. In exemplary embodiments, the back surface of back support structure 12 or plate 11, i.e. the surface that contacts the post of the lift upon which the hoist assembly is being secured, can include a layer of rubber material to prevent slippage. The pulley assembly can be installed on the overhead beam of the lift. The pulley assembly can be detachably connected to the overhead beam using straps. Alternatively, pulley assembly can be detachably connected using a sling with a pulley 41 connected to the sling by a hook, ring or other available means. The hoist assembly can be powered either by a portable battery pack such as a 12V or 24V battery pack connected using electrical leads 17 and 18. Alternatively, the hoist assembly can be powered by connecting electrical leads 17 and 18 to an external power source. Cable 15 can be engaged by pulley 41, cable 15 having at a distal end a hook 16 that can be used in conjunction with chains or other means to lift a car part. In exemplary embodiments, the hoist assembly can be used to help with the installation of an engine into a vehicle. The hoist assembly can be operated using a control unit 20. An engine can be placed into a harness that can be engaged by hook 16. Cable 15 can be reeled in thus lifting the engine above a vehicle. Cable 15 can then be slowly released and the engine lowered in place into the vehicle and thus installed.

In yet an alternative embodiment, the portable hoist assembly can be used in providing rescue or patient transport. For example, the hoist assembly can be used in conjunction with first respondent vehicles to lift a person or load that may be trapping or pinning an individual to the ground. The bridal system described earlier with respect to the scissor lift and illustrated in FIGS. 3-4 can also be designed to lift a patient from one hospital bed to another. The same bridal design can be used. Alternatively, a sheet can be used instead of a net. In yet alternative embodiments, a cot like structure can be used over which a patient can lie down while the patient is being lifted along with the cot like structure. The pulley assembly can be connected to the ceiling. Alternatively, the pulley assembly can be connected to a portable frame that can be installed and taken apart as needed. The pulley assembly may also be attached to an ambulance or other vehicle. Likewise, the portable hoist assembly can be secured to a wall, heavy piece of furniture like a hospital bed or the like, or the side of an ambulance or other vehicle. The hoist assembly and pulley assembly can then be disconnected and moved to various locations within the hospital or to be carried around in the ambulance or other vehicle so that they can be used as needed.

In yet an alternative embodiment, the portable hoist assembly and pulley assembly can be used in conjunction with a moving truck. The hoist assembly can, for example be connected to the truck. Alternatively, the hoist assembly can be connected to a structure that is proximate to the moving truck. Similar fastening means as described earlier can be used to secure the hoist assembly. The pulley assembly can likewise be connected to the roof of the moving truck or alternatively to a nearby overhead structure. The distal end of cable 15, equipped with a hook or other connecting means 16 can be used to engage a load, such as a piece of furniture, supplies, or good, to be loaded or unloaded into the moving truck. In exemplary embodiments, the bridal system described earlier can also be used to help load and unload the truck. Once the truck is loaded or unloaded, the hoist assembly and pulley assembly can be detached from their respective anchoring structures and placed in the moving truck for later use.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A portable hoist assembly system comprising:
a portable hoist assembly, comprising:
a hoist including a cable and a motor;
a support base including a plate, wherein the plate is attached to the hoist;
at least one fastener on the support base for removably securing the portable hoist assembly to a first anchoring structure; and
a portable pulley assembly including a pulley and one or more fasteners for removably secure the pulley assembly to a second anchoring structure.

2. The portable hoist assembly system of claim 1, the hoist assembly further comprising a control unit having one or more switches or buttons.

3. The portable hoist assembly system of claim 2, wherein the control unit wirelessly controls the motor.

4. The portable hoist assembly system of claim 1, wherein the support base further comprises a back support structure attached to the plate.

5. The portable hoist assembly system of claim 1, the support base further comprising multiple plates interchangeable with each other, each plate having a different design.

6. The portable hoist assembly system of claim 4, wherein the support base further comprises multiple back support structures interchangeable with each other, each back support structure having a different design.

7. The portable hoist assembly system of claim 1, wherein the portable hoist assembly weighs no more than 100 lb.

8. The portable hoist assembly system of claim 1, wherein the motor further comprises a magnetic brake.

9. The portable hoist assembly system of claim 2, further comprising at least one sensor that can monitor one or more of the weight of the load, operating conditions of the motor, and conditions of the plate.

10. The portable hoist assembly system of claim 9, wherein the sensors are in communication with the control unit.

11. The portable hoist assembly system of claim 2, the control unit further comprising a display.

12. The portable hoist assembly system of claim 1, wherein the hoist assembly is made of aluminum/steel alloy.
